(19) United States
(12) Patent Application Publication
(10) Pub. No.: US 2012/0066542 A1
(43) Pub. Date: Mar. 15, 2012

(54) Method for Node Addition and Removal of a Circuit

(75) Inventors: Yung-Chih Chen, Zhubei City (TW); Chun-Yao Wang, HsinChu City (TW)

(73) Assignee: National Tsing Hua University, Hsin Chu City (TW)

(21) Appl. No.: 12/880,474

(22) Filed: Sep. 13, 2010

(51) Int. Cl. G06F 11/20

(52) U.S. Cl. 714/4.3; 714/E11.073; 714/6.32

(57) ABSTRACT

The present invention discloses a method for node addition and removal of a circuit. The steps of the method include: (a) providing a circuit with a plurality of nodes; (b) selecting a target node for computing mandatory assignments (MAs) of stuck-at 0 and stuck-at 1 fault tests on the target node, respectively, by a processing unit; (c) finding an added substitute node by utilizing the MAs of stuck-at 0 and stuck-at 1 fault tests of the target node by the processing unit; and (d) replacing the target node by using the added substitute node closest to primary inputs; and (e) the steps (b)˜(d) are repeated for removing the replaceable nodes and simplifying the circuit.

### TECHNICAL FIELD

The present invention relates to a method for detection of node mergers in a circuit, and more particularly to a method for node addition and removal by using logic implications.

### BACKGROUND

With rapid development of semiconductor process technology, the designs of very-large scale integrated (VLSI) circuits become more complex. For a more complicated design of a VLSI circuit, the internal feature of the VLSI circuit will produce redundancy, which means the same data are stored repeatedly causing waste of space of the VLSI circuit.

Thus, in order to reduce the redundancy for simplifying the VLSI circuits, typically, engineers use a method of merging nodes. Merging nodes comprises a way of using a node to replace another node in a circuit without changing the overall functionality of the circuit, so that the redundancies are removed effectively for reducing the size of the VLSI circuit.

Boolean satisfiability (SAT) sweeping method is proposed to merge two functionally equivalent nodes to achieve aforementioned purpose. The steps of the method includes: first, a circuit is simulated by applying a set of random patterns; next, the node merger candidates are derived by searching two nodes that have the same simulation values; finally, a SAT solver is used to check if these nodes are actually equivalent. (Please refer to A. Kuehlmann, “Dynamic Transition Relation Simplification for Bounded Property Checking,” in Proc. Int. Conf on Computer-Aided Design, 2004, pp. 50-57.) The mentioned-above method merges the nodes possessing functional equivalence for simplifying the VLSI circuit. However, SAT solving operation could be very complicated and spend much time. The SAT-based method needs to repeatedly execute the SAT solver so that this method is potentially time-consuming, especially, when it is utilized to simplify a large circuit. Additionally, the functional equivalence is not a necessary condition for node merging. In fact, if the functional differences of two nodes are not observed at any primary output (PO), these two nodes can be merged as well. This refers to so-called ODCs (Observailibity Don't Care). Based on this concept, the local ODC-based algorithm extends the SAT sweeping method to merge two nodes that are not functionally equivalent to each other for further simplifying a VLSI circuit. (Please refer to Q. Zhu, N. Kitchen, A. Sangiovanni-Vincentelli, “SAT Sweeping with Local Observability Don't Cares,” in Proc. Design Automation conf., 2006, pp. 229-234.)

FIGS. 1A-B illustrate the node mergers under local ODCs. In the prior art, an And-Inverter Graph (AIG) is used to present a circuit for simplifying the circuit. In this circuit, it has four primary inputs (PIs), shown as a, b, c, and d, respectively. Moreover, nodes u₁˜u₅ are all 2-input AND gates. In this illustration, a dot marked on an edge indicates that an inverter (INV) is in between two nodes.

At first, referring to FIG. 1A, in the circuit 1, the nodes u₁ and u₃ are not functionally equivalent, and thus, merging them potentially affects the overall functionality of the circuit 1. However, the values of nodes u₁ and u₃ only differ when d=1 and b=c. The expression of b=c implies node u₂=0. Since u₂=0 is an input-controlling value of node u₅, it prevents a different value of node u₃ from being observed at node u₅. Thus, this situation makes the different values of node u₃ with respect to node u₁ never observed at any PO. Therefore, replacing node u₃ with node u₁ does not change the overall functionality of the circuit 1. Referring to FIG. 1B, the circuit 1′ is a simplified version of the circuit 1 after the node u₃ is replaced with the node u₁. FIG. 1B shows the PO is not affected by replacing the node u₃ with the node u₁. Thus, the nodes u₁ and u₃ can be merged for simplifying the circuit.

Although this method can detect more node mergers than SAT sweeping method, it sets a k-bounded depth to extract local ODCs because full observability computation is very time-consuming. Thus, with larger values of k, the method can identify more node mergers but spends much calculating time.

On the other hand, another work proposes a node-merging algorithm under global ODCs by extending the SAT sweeping technique as well in recent years (Please refer to S. Plaza, K. H. Chang, I. Markov, and V. Bertacco, “Node Mergers in the presence of Don't cares,” in Proc. Asia South Pacific Design Automation Conf., 2007, pp. 414-419.). This method is not limited to a k-bounded depth, and can detect certain node mergers that cannot be identified by the local ODC-based method. However, this method potentially misses some other node mergers as well due to approximate ODCs calculation.

Although the SAT-based techniques with local ODCs and global ODCs as mentioned above for detecting node mergers and simplifying the VLSI circuit decrease the complexity of observability computation, they cannot avoid performing ODC analysis in searching for a node merger. Additionally, they need to simulate a large amount of random patterns, collect candidate node mergers, and then perform SAT solving. This procedure can be very time-consuming due to a potentially large number of SAT solving calls when the number of candidates is enormous.

Additionally, these previous works only focus on searching and merging two nodes that originally exist in a circuit. Given a target node in a circuit that possesses no substitute node, the node-merging approaches fail to replace the target node. Thus, a new method for simplification of VLSI circuits is provided.

### SUMMARY

One objective of the present invention is to effectively merge nodes by node addition and removal of a circuit for simplifying a VLSI circuit.

Another objective of the present invention is to enhance the mentioned-above traditional detection method of node mergers by saving the CPU time.

In order to achieve the foregoing objectives, the present invention provides a method for node addition and removal of a circuit. The steps of the method include: (a) providing a circuit with a plurality of nodes; (b) selecting a target node for computing mandatory assignments (MAs) of stuck-at 0 and stuck-at 1 fault tests on the target node, respectively, by a processing unit; (c) finding an added substitute node by utilizing the MAs of stuck-at 0 and stuck-at 1 fault tests of the target node by the processing unit; and (d) replacing the target node by using the added substitute node closest to primary inputs.

Moreover, the present invention also provides a method for node addition and removal of a circuit. The steps of the method include: (a) providing a circuit with a plurality of nodes; (b) selecting a target node for computing mandatory assignments (MAs) of stuck-at 0 and stuck-at 1 fault tests on the target node, respectively, by a processing unit; (c) finding an added substitute node by utilizing the MAs of stuck-at 0 and stuck-at 1 fault tests of the target node by the processing unit; and (d) replacing the target node by using the added substitute node closest to primary inputs; and (e) the steps (b)˜(d) are repeated for removing the replaceable nodes and simplifying the circuit.

Furthermore, the present invention still provides a method for node addition and removal of a circuit. The steps of the method include: (a) providing a circuit including a plurality of nodes; (b) selecting a target node for computing mandatory assignments (MAs) of stuck-at 0 and stuck-at 1 fault tests on the target node, respectively, by a processing unit; (c) finding an added substitute node by reversing the values of the MAs of stuck-at 0 and stuck-at 1 fault tests of the target node by the processing unit; and (d) replacing the target node by using the added substitute node closest to primary inputs.

The advantage of the present invention is to provide a method for node addition and removal of a circuit using logic implications under the ODCs. Thus, the node mergers are detected by using logic implications and techniques of redundancy removal and MA reuse, for simplifying a VLSI circuit effectively and efficiently.

A detailed description is given in the following embodiments and with reference to the accompanying drawings and claims.

### BRIEF DESCRIPTION OF THE DRAWINGS

FIG. 1 shows an illustration of node mergers under local ODCs.

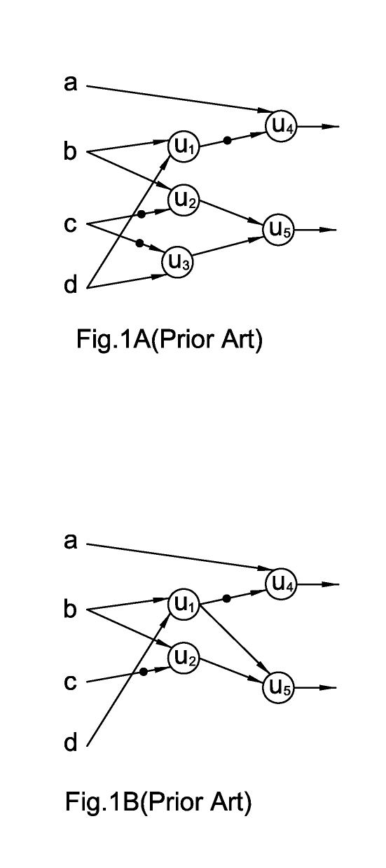

FIG. 2 shows the flow chart of the method for node addition and removal of a circuit according to the present invention.

FIGS. 3A-3D illustrate an example of NAR.

FIGS. 4A-4H illustrate eight types of added substitute nodes.

FIGS. 5A-B show two rules for MA reuse.

### DETAILED DESCRIPTION

The invention hereinafter will be described in detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Furthermore, the scope of the present invention is expressly not limited to any particular embodiments except what is specified in the appended Claims.

The present invention and embodiments now are described in detail. In the diagrams and descriptions below, the same symbols are utilized to represent the same or similar elements. The main features of the embodiments of the present invention are described in highly simplified illustrations. Additionally, the drawings of the present invention do not indicate every characteristic of the actual embodiments, and all elements of the drawings are not depicted in proportional sizes but in relative sizes.

Previous node-merging techniques focus on replacing one node with an existing node in a circuit, but fail to replace a node that has no substitute node. In fact, we observe that a target node without any substitute node could be replaced with a newly-added node. That is, we could add a node into the circuit to replace the target node. For the objective of circuit optimization, once more than one node is removed due to the addition of a new node, the circuit size is reduced as well. Therefore, the present invention provides a method for node addition and removal of a circuit by using logic implications under the concept of ODCs. In this invention, it presents a logic restructuring technique named node addition and removal (NAR). It works by adding a node into a circuit to replace an existing node and then removing the replaced node. Two sufficient conditions are first presented that state the requirements of added nodes for correctly and safely replacing a target node. Subsequently, an NAR approach is proposed to fast detect the added nodes by performing logic implications based on these conditions. The NAR approach may be applied to circuit minimization together with two techniques: redundancy removal and mandatory assignment reuse, which are engaged to make the approach more efficient and effective, and thereby simplifying a VLSI circuit effectively and efficiently.

In this application, an ATPG-based NAR approach is proposed that can efficiently find an added node to replace a node in a circuit. The NAR approach can replace a target node that a node-merging approach cannot handle, and thus, enhance the capability of circuit restructuring. It can quickly identify added substitute nodes by using logic implications. Moreover, an efficient algorithm is proposed for circuit size reduction based on the NAR approach.

In order to describe the features of the present invention more clearly, it reviews some terminologies used in logic synthesis and related concepts used in VLSI testing.

At first, an input of a gate g has an input-controlling value of g if this value determines the output value of g regardless of the other inputs. The inverse of the input-controlling value is called the input-noncontrolling value. For example, the input-controlling value of an AND gate is 0 and its input-noncontrolling value is 1.

Furthermore, a gate g is in the transitive fanout cone of a gate gₛ, if there exists a path from gₛ to g, and gₛ is in the transitive fanin cone of g.

Dominators of a gate g are a set of gates G such that all paths from g to any PO have to pass through all gates in G. Consider the dominators of a gate g: the side inputs of a dominator are its inputs that are not in the transitive fanout cone of g.

Additionally, in VLSI testing, a stuck-at fault is a fault model used to represent a manufacturing defect within a circuit. The effect of the fault is as if the faulty wire was stuck at either 1 or 0. A stuck-at fault test is a process to find a test which can generate the different output values in the fault-free and faulty circuits. Given a stuck-at fault f, if there exist such as a test, f is said to be testable; otherwise, f is untestable. Here, to make a stuck-at fault on a wire testable, a test needs to activate and propagate the fault effect to a PO. In a combinational circuit, an untestable stuck-at fault on a wire indicates that the wire is redundant and can be replaced with a constant value 0 or 1.

Mandatory assignments (MAs) are the unique value assignments to nodes necessary for a test to exist. Consider a stuck-at fault test on a wire, the assignments obtained by setting this wire to the fault-activating value and by setting the side inputs of dominators of this wire to the fault-propagating values are MAs. Then, these assignments can be propagated forward or backward to infer additional MAs by performing logic implications. Recursive learning is a learning method in automatic test pattern generation (ATPG), and it can be used to perform logic implications more completely. If the MAs of the fault on a wire are inconsistent, the fault is untestable, and therefore, this wire is redundant and can be removed.

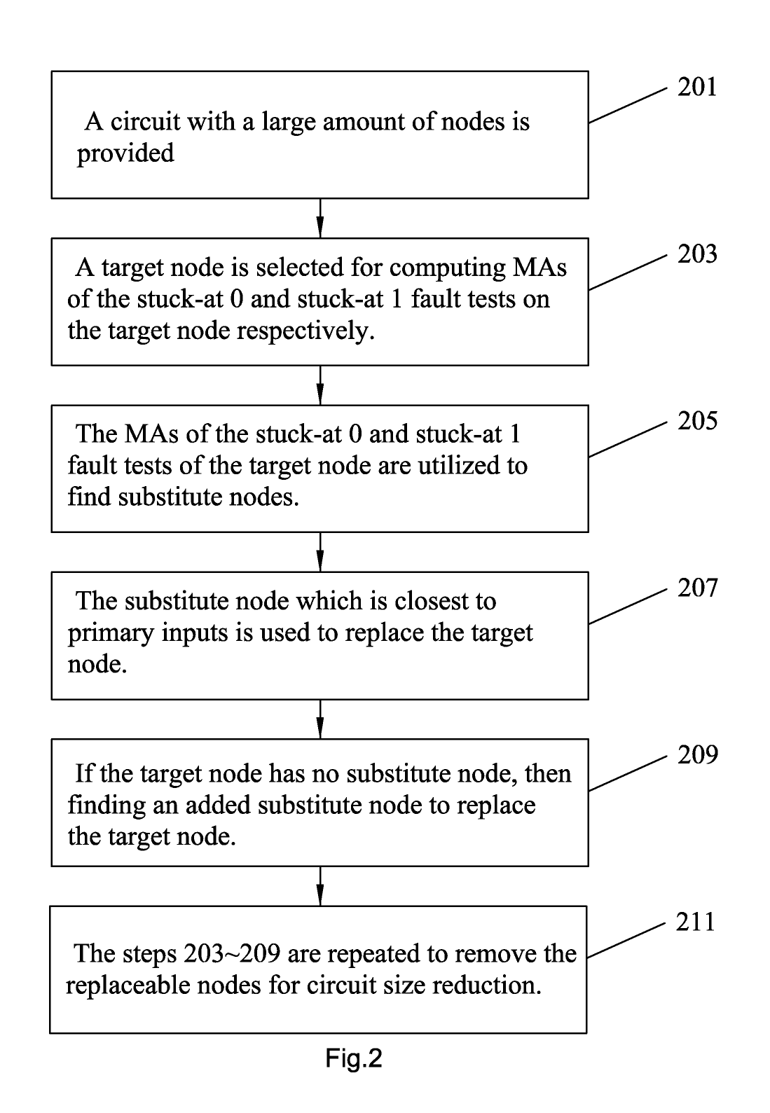

Referring to FIG. 2, it shows the flow chart of a method for node addition and removal of a circuit for circuit size reduction according to the present invention. The steps of this method include: initially, the step 201 shows that a circuit with a large amount of nodes is provided; sequentially, the step 203 shows that a target node is selected for computing MAs of the stuck-at 0 and stuck-at 1 fault tests on the target node respectively by a processing unit, such as a computer; next, the step 205 shows that the MAs of the stuck-at 0 and stuck-at 1 fault tests of the target node are utilized to find substitute nodes; furthermore, the step 207 illustrates that the substitute node which is closest to primary inputs is used to replace the target node; subsequently, the step 209 shows that if the target node has no substitute node, then finding an added substitute node to replace the target node; and in step 211, it involves that the steps 203˜209 are repeated to remove the replaceable nodes for circuit size reduction. This method disclosed in the present invention can reduce the calculating processes of the prior art dramatically, and the redundancy in a circuit can be detected quickly, followed by removing the redundancy for simplifying the circuit. The calculating process is preferably calculated by a processing unit, such as a computer.

Now, the mentioned-above steps according to the present invention are described below in detail.

Initially, in step 201, a VLSI circuit is provided, and the circuit design includes a plurality of gates. In order to simplify a logic circuit, the present description uses the And-Inverter Graph (AIG) for presenting the circuit. In the aspect, a node is defined as a feature of a logic gate. The features in steps 203˜207 may refer to Y. C. Chen and C. Y. Wang, “Fast Detection of Node Mergers Using Logic Implications,” in Proc. Int. Conf. on Computer-Aided Design, 2009, pp. 785-788. In steps 203˜207, they are used for removing the replaceable nodes having substitute nodes and simplifying the circuit. In these step, it is combined with two techniques which are redundancy removal and MA reuse. The redundancy removal is utilized to detect and remove redundancies which are obtained by the MAs calculated from the substitute node identification algorithm mentioned above. In one embodiment of the present invention, if the assignments in MAs (nₜ=sa0) are inconsistent, the target node nₜ can be replaced with a constant value “0”; and if the assignments in MAs(nₜ=sa1) are inconsistent, the target node nₜ can be replaced with a constant value “1”. Thus, replacing the target node with a constant value also reduces the complexity of the circuit. As the detection of a target node is finished, the steps 203˜207 are repeated to find substitute nodes for replacing another target node so that the redundancy in the circuit is removed and the complexity of the circuit is reduced.

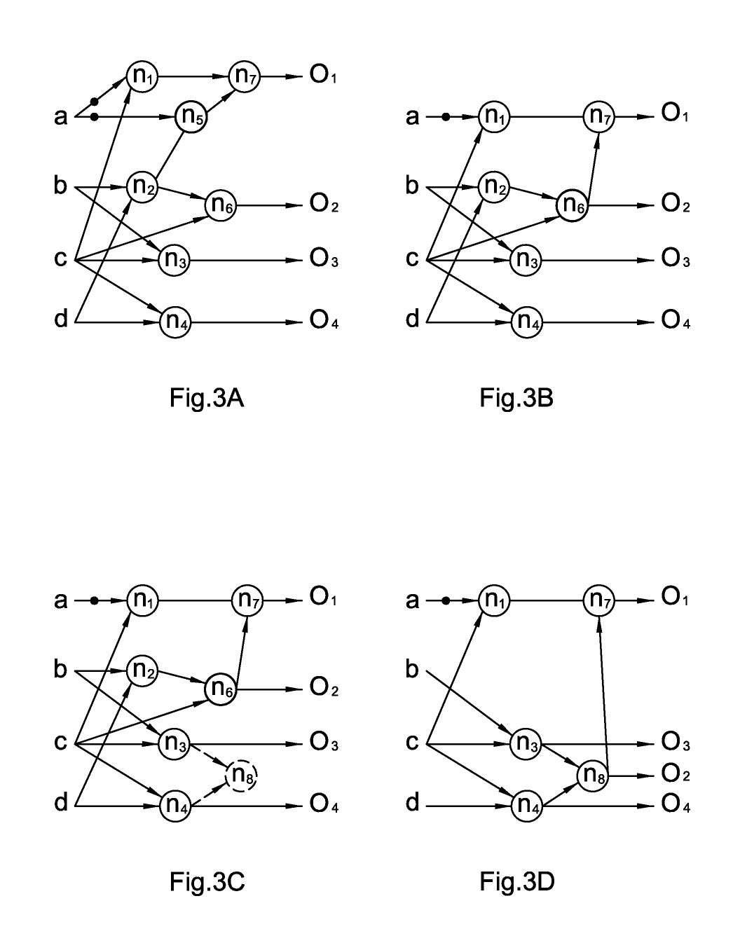

In step 209, it shows that if the target node has no substitute node, then it finds an added substitute node to replace the target node which may be performed by NAR. As shown in FIGS. 3A˜3D, these show an example of NAR, which may be employed to demonstrate the difference between node merging and NAR. For ease of discussion, the circuits considered in this application are presented as And-Inverter Graphs (AIGs), which are an efficient and scalable representation for Boolean networks. Circuits with complex gates can be handled by transforming them into AIGs first. In FIG. 3A, a, b, c, and d are primary inputs (PIs), and O1˜O4 are primary outputs (POs). n1˜n8 are 2-input AND gates. Their connectivities are presented by directed edges. A dot marked on an edge indicates that an inverter (INV) is in between two nodes. Subsequently, the node-merging technique is applied. In FIG. 3A, n5 and n6 have different functionalities. However, their values only differ when n2=1 and a=c. Because a=c further implies n1=0, which is an input-controlling value of n7, the value of n5 is prevented from being observed at O1. This situation makes the different values of n5 with respect to n6 never observed. Thus, n5 can be replaced with n6 without altering the overall functionality of the circuit. The resultant circuit is shown in FIG. 3B. Here, n5 is considered a target node and n6 is a substitute node of n5.

Next, in FIG. 3B, suppose n6 is a target node to be replaced. Because n6 does not have any substitute node, the node-merging technique fails to replace it. However, a new node can be added into the circuit to replace it. When n8 is added into the circuit, as shown in FIG. 3C, the functionality of the circuit is unchanged, because n8 does not drive any node. Additionally, n8 can correctly replace n6. The resultant circuit is shown as FIG. 3D, where n8 drives n7 and O2. This example demonstrates that a node which has no substitute node still can be replaced by a newly-added node and the resultant circuit might be minimized. Thus, the NAR technique can replace a node which cannot be replaced by the node-merging technique, and can optimize a circuit as well.

Thus, this application may address as follows: given a target node nₜ in a circuit, find a node nₐ which can correctly replace nₜ after it is added into the circuit. Here, nₐ is named an added substitute node to distinguish from a substitute node because nₐ is absent in the original circuit.

According to the ATPG-based node merging technique (Please refer to Y. C. Chen and C. Y. Wang, “Fast Detection of Node Mergers Using Logic Implications,” in Proc. Int. Conf. on Computer-Aided Design, 2009, pp. 785-788.), it proposes a node-merging algorithm by using logic implications. Such article should be incorporated in this application. It models a node replacement as a misplaced-wire error. When the error is undetectable, the replacement is safe and correct. Based on the observation, the work proposes a sufficient condition, as presented in Condition 1, that renders a misplaced-wire error undetectable.

Condition 1: Let f denote an error of replacing nₜ with nₛ. If nₛ=1 and nₛ=0 are MAs for the stuck-at 0 and stuck-at 1 fault tests on nₜ, respectively, f is undetectable. nₜ denotes a target node, and nₛ denotes a substitute node of nₜ.

The condition works because when it is held, no input pattern that can detect the error of replacing nₜ with nₛ exists. As a result, nₜ can be correctly replaced with nₛ. Based on Condition 1, the proposed algorithm in “Fast Detection of Node Mergers Using Logic Implications,” requires only two MA computations to identify the substitute nodes of a target node nₜ: one is for computing the MAs of the stuck-at 0 fault on nₜ and the other one is for computing the MAs of the stuck-at 1 fault on nₜ. The above example in FIG. 3A may be employed to demonstrate the algorithm. Suppose n5 is a target node. The MAs of the stuck-at 0 fault on n5 are {n5=1, n1=1, n2=1, b=1, d=1, a=0, c=1, n6=1, n3=1, n4=1, n7=1}. These values can be computed by setting n5=1 to activate the fault effect, setting n1=1 to propagate the fault effect, and by performing logic implications to derive additional MAs. In addition, the MAs of the stuck-at 1 fault on n5 are {n5=0, n1=1, a=0, c=1, n2=0, n6=0, n7=0}. As a result, both n2 and n6 are the substitute nodes of n5 due to the satisfaction of Condition 1. Note that although n7 also satisfies Condition 1, it is excluded from being a substitute node of n5. This is because n7 is in the transitive fanout cone (TFO) of n5, and replacing n5 with n7 will result in a cyclic combinational circuit.

Subsequently, the relationship between the node-merging and the NAR techniques is described. Based on this relationship, two sufficient conditions are derived for correctly replacing one node with an added node. Accordingly, an NAR algorithm is presented. Therefore, the sufficient conditions for NAR are provided.

As aforementioned, the node-merging technique replaces a target node with an existing node while the NAR technique uses an added one. These two techniques have one thing in common: performing node replacement. Thus, when a node is added into the circuit, Condition 1 may be exploited to check if it is an added substitute node. For example, in FIG. 3C, n6 is a target node and n8 is a node added into the circuit. It is found that n8=1 and n8=0 are MAs for the stuck-at 0 and stuck-at 1 fault tests on n6, respectively. Thus, it may conclude that n8 is an added substitute node for n6. Although Condition 1 could be used to check if an added node is a substitute node, it is not efficient to add all possible nodes into the circuit first and then identify which are substitute nodes for the target node. Thus, the problem of finding an added substitute node may be transformed into finding its two fanin nodes. It is more appropriate to find two nodes that are originally in the circuit.

The objective now becomes finding two nodes such that the added node driven by them will satisfy Condition 1. For convenience, nₜ denotes a target node and nₐ denotes an added node driven by two nodes n_{f1} and n_{f2}. n_{f1} denotes a fanin node of nₐ, and n_{f2} denotes the other fanin node of nₐ different from n_{f1}. For ease of discussion, it is supposed that nₐ is directly driven by n_{f1} and n_{f2} without any INV in between them. That is, the functionality of nₐ is n_{f1}/\n_{f2}. Next, two sufficient conditions are presented for such nₐ. Finally, the sufficient conditions are also extended for all eight different types of added nodes. The first condition is presented in Condition 2.

Condition 2: If both n_{f1}=1 and n_{f2}=1 are MAs for the stuck-at 0 fault test on nₜ, nₐ=1 is an MA for the same test as well. Because nₐ equals n_{f1}/\n_{f2}, {nn=1, n_{f2}=1} implies nₐ=1. Thus, if both n_{f1}=1 and n_{f2}=1 are MAs, nₐ=1 must be an MA as well by logic implications. In fact, when Condition 2 is held, nₐ satisfies one half of Condition 1 that nₐ=1 is an MA for the stuck-at 0 fault test on nₜ. If it can further shows that nₐ=0 is an MA for the stuck-at 1 fault test on nₜ, it can conclude that nₐ is an added substitute node of nₜ. Thus, the next sufficient condition as presented in Condition 3 is proposed to make nₐ satisfy the other half of Condition 1. Here, imp(A) denotes the set of value assignments logically implied from a set of value assignments A, and MAs (nₜ=sav) denotes the set of MAs for the stuck-at v fault test on nₜ, where v is a logical value 0 or 1.

Condition 3: If n_{f2}=0 is a value assignment in imp((n_{f1}=1)∪MAs(nₜ=sa1)), nₐ=0 is an MA for the stuck-at 1 fault test on nₜ. To determine whether nₐ=0 is an MA for the stuck-at 1 fault test on nₜ, it can check if all input patterns that can detect the fault generate nₐ=0. If so, nₐ=0 is an MA. T denotes the set of input patterns that can detect the stuck-at 1 fault on nₜ. According to the value of n_{f1}, it can classify T into two subsets: the first one, Tn_{f1}=0, and the second one, Tn_{f1}=1. Tn_{f1}=0 denotes the set of input patterns in T that generate n_{f1}=0. Tn_{f1}=1 denotes the set of input patterns in T that generate n_{f1}=1. Because n_{f1}=0 implies nₐ=0, all patterns in Tn_{f1}=0 generate nₐ=0. As for Tn_{f1}=1, imp((n_{f1}=1)∪MAs(nₜ=sa1)) is also the set of unique value assignments that all patterns in Tn_{f1}=1 generate. If n_{f2}=0 is a value assignment in imp((n_{f1}=1)∪MAs(nₜ=sa1)), all patterns in Tn_{f1}=1 must generate n_{f2}=0, implying that nₐ=0 as well. As a result, when Condition 3 is held, each pattern in T generates nₐ=0. Hence, nₐ=0 is an MA for the stuck-at 1 fault test on nₜ. In summary, when Conditions 2 and 3 are held simultaneously, nₐ=1 and nₐ=0 are MAs for the stuck-at 0 and stuck-at 1 fault tests on nₜ, respectively, and nₐ is an added substitute node of nₜ. It is noted that none of n_{f1} and n_{f2} represents a particular fanin node of nₐ. When one fanin node of nₐ is determined as n_{f1}, the other fanin node is n_{f2}. Thus, although n_{f1}=0 εimp((n_{f2}=1) ∪MAs(nₜ=sa1)) is also a sufficient condition for nₐ=0 to be an MA for the stuck-at 1 fault test on nₜ, it does not state it in Condition 3. It can be ignored by always selecting the node having a value 1 as n_{f1}.

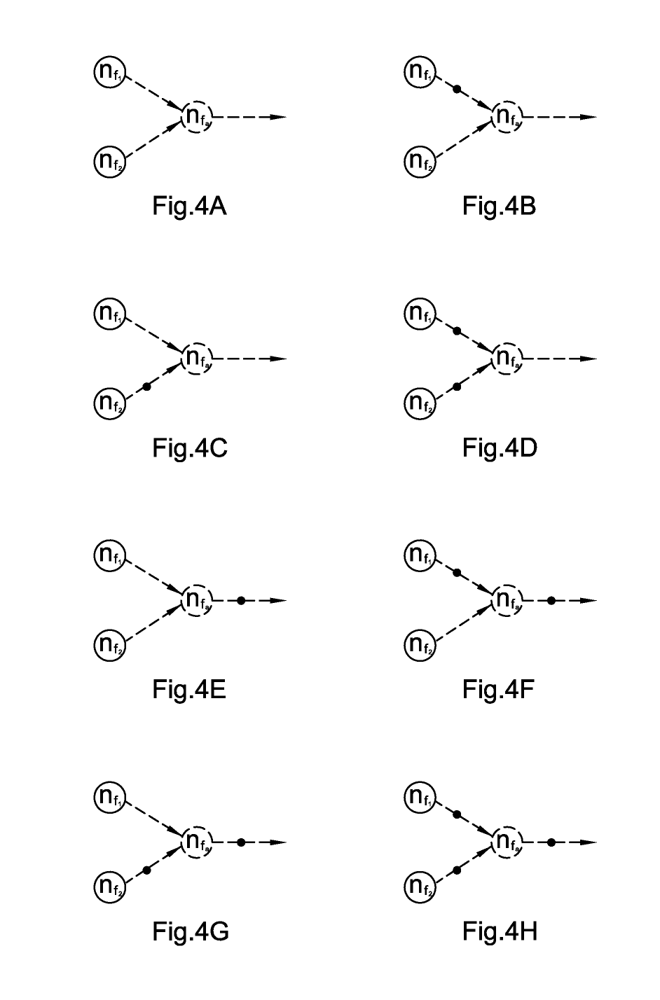

In the last discussion, it is supposed that an added node is directly driven by two nodes without any INV in between them, and then derive Conditions 2 and 3. In fact, these conditions can be modified by reversing the values of n_{f1}, n_{f2}, or the stuck-at fault for different types of added substitute nodes. In other words, types of added substitute nodes may be selected. Now, eight types of added substitute nodes and their corresponding sufficient conditions are shown in FIGS. 4A-4H and presented as follows:

{n_{f1}=1, n_{f2}=1}εMAs(nₜ=sa0)

n_{f2}=0εimp((n_{f1}=1)∪MAs(nₜ=sa1) Type 1

{n_{f1}=0, n_{f2}=1}εMAs(nₜ=sa0)

n_{f2}=0εimp((n_{f1}=0)∪MAs(nₜ=sa1) Type 2

{n_{f1}=1, n_{f2}=0}εMAs(nₜ=sa0)

n_{f2}=1εimp((n_{f1}=1)∪MAs(nₜ=sa1) Type 3

{n_{f1}=0, n_{f2}=0}εMAs(nₜ=sa0)

n_{f2}=1εimp((n_{f1}=0)∪MAs(nₜ=sa1) Type 4

{n_{f1}=1, n_{f2}=1} MAs(nₜ=sa1)

n_{f2}=0 imp((n_{f1}=1)∪MAs(nₜ=sa0) Type 5

{n_{f1}=0, n_{f2}=1} MAs(nₜ=sa1)

n_{f2}=0 imp((n_{f1}=0)∪MAs(nₜ=sa0) Type 6

{n_{f1}=1, n_{f2}=0} MAs(nₜ=sa1)

n_{f2}=1 imp((n_{f1}=1)∪MAs(nₜ=sa0) Type 7

{n_{f1}=0, n_{f2}=0} MAs(nₜ=sa1)

n_{f2}=1 imp((n_{f1}=0)∪MAs(nₜ=sa0) Type 8

For example, Type 1 is the original added node, shown in FIG. 4A. By reversing the value of n_{f1} in Conditions 2 and 3, Type 2 is provided shown in FIG. 4B, nₐ equals [symbol] _{f1} n_{f2}. Similarly, if reversing the value of n_{f2}, Type 3 is created shown in FIG. 4C, nₐ equals n_{f1} [symbol] _{f2}. For Type 4, nₐ equals [symbol] _{f1} [symbol] _{f2}, by reversing the values of n_{f1} and n_{f2} simultaneously, shown in FIG. 4D. For Types 5-8, they are corresponding to Types 1-4, respectively. The stuck-at fault values in Types 1-4 could be reversed to obtain Types 5-8, shown in FIG. 4E-4H respectively.

Subsequently, NAR algorithm is described. Given a target node nₜ, it can exploit Conditions 2 and 3 to find its added substitute nodes. Based on Condition 2, it always selects an MA in MAs(nₜ=sav) as a candidate n_{f1}, and then use the n_{f1} and Condition 3 to find n_{f2}. The proposed algorithm of finding added substitute nodes is shown as follows:

Find Added Substitute Node (Node nₜ)

1. Compute MAs(nₜ=sa0).

2. Compute MAs(nₜ=sa1).

3. For each MA n=v in MAs(nₜ=sa0)
(a) Let n be n_{f1}.
(b) Compute imp((n_{f1}=v)∪MAs(nₜ=sa1)).
(c) The n_{f2} set←−Nodes that have different values in MAs(nₜ=sa0) and imp((n_{f1}=v)∪MAs(nₜ=sa1)).

4. The nₐ set of Types 1˜4←−Nodes driven by n_{f1} and n_{f2}.

5. For each MA n=v in MAs(nₜ=sa1)
(a) Let n be n_{f1}.
(b) Compute imp((n_{fl1}=v)∪MAs(nₜ=sa0)).
(c) The n_{f2} set←−Nodes that have different values in MAs(nₜ=sa1) and imp((n_{f1}=v)∪MAs(nₜ=sa0)).

6. The nₐ set of Types 5-8←−Nodes driven by n_{f1} and n_{f2}.

In this application, the proposed algorithm may consider all these possible added substitute nodes when performing NAR. In the first two steps, the algorithm computes MAs(nₜ=sa0) and MAs(nₜ=sa1), respectively. In step 3, the algorithm starts to find the added substitute nodes of Types 1-4 mentioned above. It iteratively selects an MA n=v from MAs(nₜ=sa0) and sets n_{f1} to n. Then, it computes imp((n_{f1}=v)∪MAs(nₜ=sa1)) by performing logic implications of n_{f1}=v associated with MAs(nₜ=sa1). Finally, the nodes that have different values in MAs(nₜ=sa0) and imp((n_{f1}=v)∪MAs(nₜ=sa1)) can be n_{f2}. Thus, in step 4, the nodes that driven by n_{f1} and n_{f2} are the added substitute nodes of Types 1-4. In steps 5 and 6, the algorithm uses a similar method to find the added substitute nodes of Types 5-8 mentioned above.

It is noted that the algorithm of aforementioned is designed to find all added substitute nodes. If the objective is to identify one added substitute node or check if a target node is replaceable, the algorithm can be terminated once it finds an n_{f1} and n_{f2} pair. Additionally, it will ensure that an added substitute node is not in the TFO of the target node and has at least one different fanin node from that of the target node.

As aforementioned, the example in FIGS. 3A-3D is employed to demonstrate the algorithm. It is considered that finding an added substitute node of n6 in the circuit of FIG. 3B. First, the MAs for the stuck-at 0 fault on n6 are computed. To activate the fault effect, n6 is set to 1. Logic implications are then performed to derive additional MAs. They are n2=1, c=1, b=1, d=1, n3=1, and n4=1. Thus, MAs(nₜ=sa0) includes {n6=1, n2=1, c=1, b=1, d=1, n3=1, n4=1}. Second, it may use the same method to compute the MAs for the stuck-at 1 fault on n6. They are {n6=0, n7=0}. Third, suppose n3 is selected as n_{f1} and it computes imp((n3=1)∪MAs(n6=sa1)). The implication results have {n6=0, n7=0, n3=1, b=1, c=1, n2=0, d=0, n4=0}. Finally, n2, d, and n4 all can be n_{f2} due to the satisfaction of Conditions 2 and 3. If n4 is selected as n_{f2}, n8 driven by n3 and n4 is an added substitute node of n6 as shown in FIG. 3C.

In this application, an NAR-based algorithm is presented for circuit size reduction. The node-merging technique is also included in the algorithm to quickly replace a node having a substitute node. In addition, two techniques, redundancy removal and MA reuse, are engaged to enhance the performance of the algorithm.

For node-merging technique, in the proposed NAR algorithm, it computes MAs(nₜ=sa0) and MAs(nₜ=sa1) in the first two steps. As aforementioned, the ATPG-based node-merging approach only requires MAs(nₜ=sa0) and MAs(nₜ=sa1) to find substitute nodes. Thus, the present invention may employ the node-merging approach with the NAR algorithm for circuit size reduction. Given a target node, after computing MAs(nₜ=sa0) and MAs(nₜ=sa1), the node-merging approach may be employed to find its substitute nodes for replacement. If there is no substitute node, it continues to find its added substitute nodes. This approach saves the effort of finding an added substitute node when there is a substitute node.

Moreover, for redundancy removal, as aforementioned, MAs are the unique value assignments to nodes necessary for a test to exist. Given a stuck-at fault on a node, when the MAs are inconsistent, the fault is untestable and the node is redundant. The NAR algorithm computes MAs(nₜ=sa0) and MAs(nₜ=sa1), and hence can simultaneously find untestable faults. Once it is found that the assignments in MAs(nₜ=sa0) are inconsistent, nₜ may be replaced with a constant value 0 and employing 0 to drive all the wires originally driven by nₜ. Similarly, if the assignments in MAs(nₜ=sa1) are inconsistent, nₜ may be replaced with a constant value 1. Thus, for circuit size reduction, it can identify these redundancies and remove them without extra effort.

Because a VLSI circuit is very huge and complex, the present invention also provides the technique of MA reuse to accelerate the optimization process. MA reuse is a method to reuse the computed MAs such that the number of performed logic implications can be reduced and the optimization process is accelerated. The idea comes from the concept of fault collapsing (please refer to M. Abramovici, M. A. Breuer, and A. D. Friedman, Digital Systems Testing and Design for Testability, IEEE Press, 1990.) that two equivalent stuck-at faults have the same test set. Based on this concept, when two stuck-at faults are equivalent, their corresponding MAs are identical as well. Thus, the computed MAs can be reused.

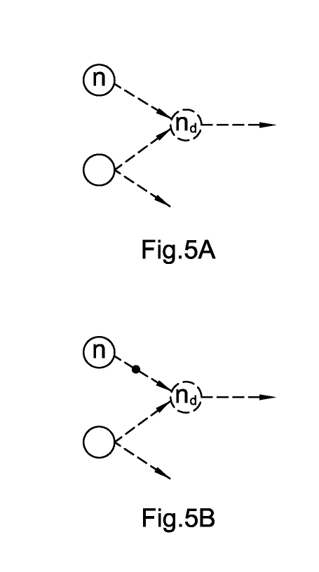

Now, referring to FIGS. 5A, 5B, it shows an embodiment of the present invention: two rules for MA reuse may be simply derived. Suppose n drives only n_{d} and MAs(n_{d}=sa0) has been computed. Computing the MAs for the stuck-at fault tests on a node n with MA reuse may be considered. As shown in FIG. 5A, if there exists no INV between n and n_{d}, MAs(n=sa0) may directly set to MAs(n_{d}=sa0) rather than re-compute the same MA set. Otherwise, if there exists an INV between n and n_{d} as shown in FIG. 5B, MAs(n=sa1) may directly set to MAs(n_{d}=sa0). In summary, for each node n_{d}, only MAs(n_{d}=sa0) can be reused. Additionally, it is reused when n_{d} has a fanin node n which drives only n_{d}.

During the optimization process, each node in a circuit is considered a target node, one at a time. The target node's substitute nodes for replacement may be first found using the node-merging technique mentioned above. However, if there is no substitute node, NAR is then performed. In order to ensure that each node replacement can reduce the circuit size, NAR may only be performed for the target nodes that have a fanin node driving only one node. In this situation, when the target node is replaced, such fanin node can be removed as well. Thus, adding one node removes at least two nodes. As for the optimization order, although the orders of selecting a target node, a substitute node, and an added substitute node can significantly affect the optimization results, it is difficult to evaluate the most effective optimization order. Additionally, this evaluation process might be time-consuming or fruitless. Thus, in the present invention, it follows the optimization order of selecting a target node and a substitute node used by the node-merging algorithm aforementioned for fair comparison. A target node is selected from POs to PIs in the depth-first search (DFS) order and is replaced with a substitute node that is closest to PIs. Additionally, each MA node is selected as n_{f1} in a topological order to identify the n_{f2} that is closest to PIs. A target node is replaced once an added substitute node is found due to the inefficiency of finding all added substitute nodes.

Therefore, the overall algorithm for circuit size reduction according to the present invention is integrated as follows:

Circuit Size Reduction (Circuit C)

For each node nₜ in C in the DFS order from POs to PIs
1. Compute MAs(nₜ=sa0) with MA reuse.
   (a) If the MAs in MAs(nₜ=sa0) are inconsistent, replace nₜ with 0, and then continue.
   (b) If nₜ has a fanin node which drives only nₜ, store MAs(nₜ=sa0) for further reuse.
2. Compute MAs(nₜ=sa1) with MA reuse.
   (a) If the MAs in MAs(nₜ=sa1) are inconsistent, replace nₜ with 1, and then continue.
3. Substitute Nodes←−nodes having the different values in MAs(nₜ=sa0) and MAs(nₜ=sa1).
4. If Substitute Nodes#{ }, replace nₜ with a node that is in Substitute Nodes and closest to PIs, and then continue.
5. If nₜ has no fanin node which drives only nₜ, continue.
6. For each MA n=v in MAs(nₜ=sa0) in a topological order
   (a) Let n be n_{f1}.
   (b) Compute imp((n_{f1}=v)∪MAs(nₜ=sa1)).
   (c) The n_{f2} set←−Nodes that have different values in MAs(nₜ=sa0) and imp((n_{f1}=v)∪MAs(nₜ=sa1)).
   (d) If the set of n_{f2}#{ }, replace nₜ with a node driven by n_{f1} and the n_{f2} that is closest to PIs, and then break.
7. If nₜ is replaced, continue.
8. For each MA n=v in MAs(nₜ=sa1) in a topological order
   (a) Let n be n_{f1}.
   (b) Compute imp(((n_{f1}=v)∪MAs(nₜ=sa0)).
   (c) The n_{f2} set←−Nodes that have different values in MAs(nₜ=sa1) and imp((n_{f1}=v)∪MAs(nₜ=sa0)).
   (d) If the set of nₜ₂#{ }, replace nₜ with a node driven by n_{f1} and the n_{f1} that is closest to PIs, and then break.

According to the above overall algorithm for circuit size reduction, given a circuit C, the algorithm iteratively selects a target node nₜ in the DFS order from POs to PIs and replaces it if applicable. At each iteration, in step 1, the algorithm computes MAs(nₜ=sa0). If the MAs are inconsistent, it replaces nₜ with 0 and continues to consider the next target node. Otherwise, if nₜ has a fanin node that drives only nₜ, the algorithm stores the computed MAs(nₜ=sa0) for further reuse. Next, in step 2, the algorithm computes MAs(nₜ=sa1). Similarly, if the MAs in MAs(nₜ=sa1) are inconsistent, it replaces nₜ with 1 and continues to consider the next target node. Otherwise, the algorithm starts to find substitute nodes. In step 3, the nodes that have the different values in MAs(nₜ=sa0) and MAs(nₜ=sa1) are the substitute nodes of nₜ. The algorithm selects one substitute node which is closest to PIs to replace nₜ and continues to consider the next target node. However, if nₜ has no substitute node, the algorithm starts to perform NAR when nₜ has one fanin node which drives only nₜ. From steps 6-8, the algorithm finds an added substitute node to replace nₜ by using the method as the proposed algorithm of finding added substitute nodes.

For comparison, the node-merging algorithm and NAR algorithm are implemented. The experimental setup and parameters are the same with that in “Fast Detection of Node Mergers Using Logic Implications,” for fair comparison. Each benchmark is initially transformed to an AIG format and only considers its combinational portion. The experimental results consist of two parts: the first one shows the logic restructuring capability of the present invention's approach combining the node-merging and the NAR techniques; the second one shows the efficiency and effectiveness of the present invention's approach for circuit size reduction.

In the experiments, the present invention's approach is compared with the node-merging approach. Each node in a benchmark is considered a target node one at a time. It separately uses the node-merging approach and the present invention's approach to check how many nodes in a benchmark are replaceable. That is, replaceable node identification is performed. A node is considered replaceable if it has a substitute node or an added substitute node. Given a target node, the present invention's approach first finds its substitute nodes. If the present invention's approach fails to do so, it further finds the added substitute nodes. Table 1 summarizes the experimental results. Column 1 lists the benchmarks. Column 2 lists the number of nodes in each benchmark represented by AIG N. Columns 3 to 5 list the results of the node-merging approach. They contain the number of replaceable nodes Nrep, the percentage of Nrep with respect to N, and the CPU time T, respectively. Columns 6 to 8 list the corresponding results of the present invention's approach. The improvements of the present invention's approach on the number of replaceable nodes are listed in the last column. For example, the benchmark C3540 has 1038 nodes. The node-merging approach found substitute nodes for 29 out of 1038 nodes, or 2.8%, with a CPU time of 0.3 seconds. The present invention's approach found that 328 nodes, or 31.6%, have substitute nodes or added substitute nodes with a CPU time of 0.5 seconds. Thus, the present invention's approach can find 28.8% more replaceable nodes. According to Table 1, the node-merging approach can find substitute nodes for an average of 6.5% of nodes in a benchmark. The overall CPU time for all benchmarks is 589.3 seconds. As for the present invention's approach, it can find substitute nodes or added substitute nodes for an average of 34.4% of nodes in a benchmark. The overall CPU time is 1423.7 seconds. As compared with the node-merging approach, the present invention's approach can find more replaceable nodes with a reasonable CPU time overhead. The average number of replaceable nodes is 27.9% more with a ratio 5.26, and the CPU time overhead is only 834.4 seconds for all benchmarks. Because the present invention's approach identifies much more replaceable nodes, it has a better logic restructuring capability than that of the node-merging approach.

TABLE 1

| | | node-merging | | | present invention's | | | |
|---|---|---|---|---|---|---|---|---|
| | | approach | | | approach | | | impr. |
| benchmark | N | Nrep | % | T(s) | Nrep | % | T(s) | % |
| C3540 | 1038 | 29 | 2.8 | 0.3 | 328 | 31.6 | 0.5 | 28.8 |
| rot | 1063 | 42 | 4.0 | 0.2 | 384 | 36.1 | 0.3 | 32.8 |
| simple_spi | 1079 | 26 | 2.4 | 0.1 | 234 | 21.7 | 0.3 | 19.3 |
| i2c | 1306 | 80 | 6.1 | 0.2 | 528 | 40.4 | 0.4 | 34.3 |
| pci_spoci_ctrl | 1451 | 170 | 11.7 | 0.6 | 630 | 43.4 | 1.5 | 31.7 |
| dalu | 1740 | 217 | 12.5 | 1.0 | 885 | 50.9 | 3.1 | 38.4 |
| C5315 | 1773 | 33 | 1.9 | 0.2 | 279 | 15.7 | 0.3 | 13.9 |
| s9234 | 1958 | 175 | 8.9 | 0.4 | 827 | 42.2 | 0.7 | 33.3 |
| C7552 | 2074 | 60 | 2.9 | 0.4 | 691 | 33.3 | 0.7 | 30.4 |
| C6288 | 2337 | 2 | 0.1 | 0.5 | 932 | 39.9 | 1.4 | 39.8 |
| i10 | 2673 | 626 | 23.4 | 1.4 | 1493 | 55.9 | 2.8 | 32.4 |
| s13207 | 2719 | 159 | 5.9 | 0.6 | 891 | 32.8 | 1.7 | 26.9 |
| systemcdes | 3190 | 147 | 4.6 | 1.5 | 1355 | 42.5 | 2.6 | 37.9 |
| i8 | 3310 | 1533 | 46.3 | 3.8 | 2522 | 76.2 | 7.2 | 29.9 |
| spi | 4053 | 65 | 1.6 | 3.4 | 950 | 23.4 | 6.6 | 21.8 |
| des_area | 4857 | 80 | 1.7 | 5.6 | 891 | 18.3 | 13.3 | 16.7 |
| alu4 | 5270 | 206 | 3.9 | 54.9 | 2852 | 54.1 | 83.6 | 50.2 |
| s38417 | 9219 | 173 | 1.9 | 1.4 | 2319 | 25.2 | 2.4 | 23.3 |
| tv80 | 9609 | 496 | 5.2 | 17.2 | 3415 | 35.5 | 41.6 | 30.4 |
| b20 | 12219 | 849 | 7.0 | 17.3 | 4424 | 36.2 | 34.6 | 29.3 |
| s38584 | 12400 | 549 | 4.4 | 17.0 | 4385 | 35.4 | 66.2 | 30.9 |
| b21 | 12782 | 1094 | 8.6 | 19.3 | 5249 | 41.1 | 39.5 | 32.5 |
| systemcaes | 13054 | 202 | 1.6 | 17.7 | 2888 | 22.1 | 36.8 | 20.6 |
| ac97_ctrl | 14496 | 98 | 0.7 | 3.2 | 1428 | 9.9 | 7.5 | 9.2 |
| mem_ctrl | 15641 | 1537 | 9.8 | 98.8 | 3443 | 22.0 | 178.0 | 12.2 |
| usb_funct | 15894 | 370 | 2.3 | 6.3 | 3430 | 21.6 | 16.7 | 19.3 |
| b22 | 18488 | 1047 | 5.7 | 25.0 | 6497 | 35.1 | 53.8 | 29.5 |
| aes_core | 21513 | 452 | 2.1 | 15.2 | 8076 | 37.5 | 39.9 | 35.4 |
| pci_bridge32 | 24369 | 309 | 1.3 | 21.7 | 3700 | 15.2 | 47.2 | 13.9 |
| wb_conmax | 48429 | 5608 | 11.6 | 28.2 | 13492 | 27.9 | 116.0 | 16.3 |
| b17 | 52920 | 1565 | 3.0 | 174.5 | 17473 | 33.0 | 533.8 | 30.1 |
| des_perf | 79288 | 2505 | 3.2 | 51.4 | 34376 | 43.6 | 82.7 | 40.2 |
| average | | | 6.5 | | | 34.4 | | 27.9 |
| total | | | | 589.3 | | | 1423 | |
| ratio | | | 1 | | | 5.26 | | |

In order to enhance the advantage of the present invention, the comparison results of the present invention with the prior art are illustrated in Table 2. Furthermore, in the experiments, the present invention's approach is compared with the ATPG-based node-merging approach as well as the SAT-based node-merging approach (please refer to S. Plaza, K. H. Chang, I. Markov, and V. Bertacco, “Node Mergers in the Presence of Don't Cares,” in Proc. Asia South Pacific Design Automation Conf., 2007, pp. 414-419) for circuit size reduction. Table 2 summarizes the experimental results. Columns 1 and 2 list the benchmarks and the number of nodes in each benchmark represented by AIG, respectively. Columns 3 and 4 list the results of the SAT-based node-merging approach aforementioned, the percentage of circuit size reduction in terms of node count and the CPU time, respectively. The maximal CPU time in Column 4 is 5000 seconds, which is the CPU time limit set by the work. Columns 5 to 7 list the results of the ATPG-based node-merging approach. They contain the number of nodes in each resultant benchmark Nr, the percentage of circuit size reduction, and the CPU time, respectively. Columns 8 to 10 list the corresponding results of the present invention's approach. The experimental results in Table 2 show that the present invention's approach is 44.03 times faster than the SAT-based node-merging approach and has a competitive capability of circuit size reduction. Additionally, the present invention's capability is better than that of the ATPG-based node-merging approach with a ratio of 1.27. The overall CPU time overhead is only 242.8 seconds. Moreover, because the present invention's approach is highly efficient, it can be combined with the resyn2 script to achieve more circuit size reduction. The benchmarks listed in Table 2 are optimized by repeatedly using the present invention's approach followed by the resyn2 script 3 times−(ours+resyn2)×3. The average circuit size reduction is 8.6% and the CPU time is 1453.1 seconds. On the other hand, if these benchmarks are optimized by repeatedly using the resyn2 script 6 times−resyn2×6, the average circuit size reduction is only 4.3% with a CPU time of 157.1 seconds. In addition, the average circuit size reduction is 5.9% and the CPU time is 2691.2 seconds by repeatedly using the present invention's approach 6 times−the present invention's×6. The experimental results are summarized in Table 3. According to the experimental results, it can conclude that the efficiency and the logic restructuring capability of the present invention's approach can make the integration of the present invention's approach and other optimization techniques such as resyn2 possible.

The experimental results show that the present invention's approach can enhance the state-of-the-art ATPG-based node-merging approach. Additionally, the present invention's approach has a competitive capability of circuit minimization with 44 times speedup compared to a SAT-based node-merging approach. The experimental results also show that the proposed algorithm can be integrated with an optimization technique to obtain a better circuit size reduction. All these results show the efficiency and effectiveness of the proposed approach.

TABLE 2

| | | SAT-based | | ATPG-based | | | present | | |
|---|---|---|---|---|---|---|---|---|---|
| | | node-merging | | node-merging | | | invention's | | |
| | | approach | | approach | | | approach | | |
| Benchmark | N | % | T(s) | Nr | % | T(s) | Nr | % | T(s) |
| pci_spoci_ctrl | 878 | 9.2 | 6 | 782 | 10.9 | 0.2 | 757 | 13.8 | 0.4 |
| i2c | 941 | 3.2 | 3 | 923 | 1.9 | 0.1 | 894 | 5 | 0.2 |
| Dalu | 1057 | 12.0 | 10 | 985 | 6.9 | 0.3 | 979 | 7.4 | 0.5 |
| C5315 | 1310 | 0.7 | 2 | 1304 | 0.5 | 0.1 | 1297 | 1 | 0.1 |
| s9234 | 1353 | 1.2 | 8 | 1331 | 1.6 | 0.2 | 1323 | 2.2 | 0.2 |
| C7552 | 1410 | 3.4 | 8 | 1371 | 2.8 | 0.3 | 1356 | 3.8 | 0.3 |
| i10 | 1852 | 1.3 | 12 | 1755 | 5.2 | 0.6 | 1742 | 5.9 | 1.0 |
| s13207 | 2108 | 1.8 | 17 | 2063 | 2.1 | 0.5 | 2043 | 3.1 | 0.8 |
| alu4 | 2471 | 22.9 | 64 | 1941 | 21.5 | 5.3 | 1878 | 24 | 9.9 |
| systemcde | 2641 | 4.7 | 9 | 2600 | 1.6 | 0.9 | 2580 | 2.3 | 1.2 |
| spi | 3429 | 1.3 | 84 | 3411 | 0.5 | 2.7 | 3383 | 1.3 | 5.6 |
| tv80 | 7233 | 7.1 | 1445 | 6960 | 3.8 | 10.6 | 6813 | 5.8 | 20.3 |
| s38417 | 8185 | 1.0 | 275 | 8136 | 0.6 | 1.2 | 8105 | 1 | 1.5 |
| mem_ctrl | 8815 | 18.0 | 738 | 7257 | 17.7 | 6.8 | 7287 | 17.3 | 13.8 |
| s38584 | 9990 | 0.8 | 223 | 9846 | 1.4 | 11.4 | 9836 | 1.5 | 15.1 |
| ac97_ctrl | 10395 | 2.0 | 188 | 10379 | 0.2 | 2.0 | 10364 | 0.3 | 3.1 |
| systemcase | 10585 | 3.8 | 360 | 10521 | 0.6 | 13.1 | 10386 | 1.9 | 30.7 |
| usb_funct | 13320 | 1.4 | 681 | 13026 | 2.2 | 5.9 | 12868 | 3.4 | 11.4 |
| pci_bridge32 | 17814 | 0.1 | 1134 | 17729 | 0.5 | 12 | 17599 | 1.2 | 19.7 |
| ae_core | 20509 | 8.6 | 1620 | 20371 | 0.7 | 13.2 | 20195 | 1.5 | 22.7 |
| b17 | 34523 | 1.6 | 5000 | 33979 | 1.5 | 72.4 | 33204 | 3.8 | 205.5 |
| wb_conmax | 41070 | 6.2 | 5000 | 39266 | 4.4 | 31.9 | 38880 | 5.3 | 48.4 |
| des_perf | 71327 | 3.7 | 5000 | 70081 | 1.8 | 62.6 | 69421 | 2.7 | 84.7 |
| average | | 5.0 | | | 3.9 | | | 5.0 | |
| total | | | 21887 | | | 254.3 | | | 497.1 |
| ratio | | 1.27 | 44.03 | | 1 | 0.51 | | 1.27 | 1 |

TABLE 3

| | (our + resyn2)*3 | | resyn2*6 | | present invention's *6 | |
|---|---|---|---|---|---|---|
| | % | T(s) | % | T(s) | % | T(s) |
| average | 8.6 | | 4.3 | | 5.9 | |
| total | | 1453.1 | | 157.1 | | 2691.2 |

As mentioned-above, the method for node addition and removal and simplification of a circuit according to the present invention can merge nodes and remove nodes for simplifying a VLSI circuit effectively, and the CPU time of detecting node mergers also can be reduced successively.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalency are intended to be embraced therein.

What is claimed is:

1. A method for node addition and removal of a circuit, the steps of said method comprising:
(a) providing a circuit with a plurality of nodes;
(b) selecting a target node for computing mandatory assignments (MAs) of stuck-at 0 and stuck-at 1 fault tests on said target node, respectively, by a processing unit;
(c) finding an added substitute node by utilizing said MAs of stuck-at 0 and stuck-at 1 fault tests of said target node by said processing unit; and
(d) replacing said target node by using said added substitute node closest to primary inputs.

2. The method according to claim 1, wherein said plurality of nodes comprise a plurality of logic gates.

3. The method according to claim 2, wherein said plurality of logic gates comprises 2-input AND gates.

4. A method for node addition and removal of a circuit, the steps of said method comprising:
(a) providing a circuit including a plurality of nodes;
(b) selecting a target node for computing mandatory assignments (MAs) of stuck-at 0 and stuck-at 1 fault tests on said target node respectively by a processing unit;
(c) finding an added substitute node by utilizing said MAs of stuck-at 0 and stuck-at 1 fault tests of said target node by said processing unit;
(d) replacing said target node by using said added substitute node closest to primary inputs; and
(e) repeating said steps (b)˜(d) for removing replaceable said target node and simplifying said circuit.

5. The method according to claim 4, wherein said plurality of nodes comprise a plurality of logic gates.

6. The method according to claim 5, wherein said plurality of logic gates comprises 2-input AND gates.

7. The method according to claim 4, wherein said step (e) is engaged with a plurality of techniques, and said techniques include redundancy removal and mandatory assignment reuse.

8. The method according to claim 7, wherein said redundancy removal is that using “1” or “0” to replace said node for simplifying said circuit.

9. The method according to claim 7, wherein said mandatory assignment reuse defines that a particular node in said plurality of nodes has the same mandatory assignment set with a fanout of it, and thus, can reuse the mandatory assignments for accelerating the computing process.

10. The method according to claim 4, wherein said target node is selected by using depth-first search technique.

11. A method for node addition and removal of a circuit, the steps of said method comprising:
(a) providing a circuit including a plurality of nodes;
(b) selecting a target node for computing mandatory assignments (MAs) of stuck-at 0 and stuck-at 1 fault tests on said target node, respectively, by a processing unit; and
(c) finding an added substitute node by reversing the values of said MAs of stuck-at 0 and stuck-at 1 fault tests of said target node by said processing unit; and
(d) replacing said target node by using said added substitute node closest to primary inputs.

12. The method according to claim 11, wherein said plurality of nodes comprise a plurality of logic gates.

13. The method according to claim 12, wherein said plurality of logic gates comprises 2-input AND gates.
